(19) United States
(12) Patent Application Publication
(10) Pub. No.: US 2023/0067059 A1
(43) Pub. Date: Mar. 2, 2023

(54) PRESSURE BOOSTING SHOWER HEAD

(71) Applicant: AS America, Inc., Piscataway, NJ (US)

(72) Inventors: Jean-Jacques L'HENAFF, New Canaan, CT (US); Ki Bok SONG, Plainview, NY (US); Jacob NITZ, London (GB); Paul FLOWERS, London (GB); Greg REINECKER, Brooklyn, NY (US)

(73) Assignee: AS America, Inc., Piscataway, NJ (US)

(21) Appl. No.: 17/896,488

(22) Filed: Aug. 26, 2022

Related U.S. Application Data
(60) Provisional application No. 63/239,711, filed on Sep. 1, 2021.

(51) Int. Cl. B05B 1/18; B05B 1/34

(52) U.S. Cl. CPC B05B 1/185; B05B 1/34

(57) ABSTRACT

A shower head can include: a shower face removably mounted to the shower head, the shower face including a plurality of channels configured to deliver a spray, each channel including openings on opposite sides of the shower face; and a user-activated mechanism configured to remove the shower face from the shower head to allow customization of the spray from the shower head.

### CROSS-REFERENCE TO RELATED APPLICATIONS

This application claims the priority of U.S. Provisional Application No. 63/239,711, filed Sep. 1, 2021, the entire contents of which is incorporated herein by reference.

### FIELD OF THE DISCLOSURE

This disclosure generally relates to shower heads and more specifically to shower heads that include a removable shower face.

### BACKGROUND OF THE DISCLOSURE

Water that flows through a shower head can leave behind mineral and biological deposits that build up on or around nozzles of a shower head. Such deposits can eventually become visible to a user and at least partially block orifices of the nozzle, thereby degrading a user's shower experience. Additionally, shower heads configured to deliver water at high water pressures are more likely to become at least partially blocked with deposits when the water quality is poor. The capability to maintain a clean shower head and change a water pressure delivered from the shower head, despite poor water quality, remains a challenge.

### SUMMARY OF THE DISCLOSURE

According to some embodiments, a shower head includes a shower face comprising a plurality of channels for passing water and a user-activated actuator for removing the shower face from the shower head. When the shower face is removed from the shower head, a user may clean the shower face and configure the shower face to deliver water according to one of a plurality of pressure modes. In this way, the shower head offers a customizable shower experience for cleaning an interior of the shower head and changing water delivery through the shower face.

According to some embodiments, a shower head comprising: a shower head base; a shower face removably mounted to the shower head base, the shower face comprising a plurality of channels configured to deliver a spray, each channel comprising openings on opposite sides of the shower face; and a user-activated mechanism configured to remove the shower face from the shower head base to allow customization of the spray from the shower head.

In any of these embodiments, the shower face can be replaceable with a different shower face comprising a different plurality of channels, wherein the different plurality of channels are configured to deliver a pressure boosting spray from the shower head based on a shape and pattern of the different plurality of channels.

In any of these embodiments, the pressure boosting spray can be configured to increase water pressure across the shower face by about 10% to about 50% compared to a pressure of the spray.

In any of these embodiments, the shower face can be mountable to the shower head base with either side facing away from the shower head base and the spray of the shower head is dependent upon which side of the shower face is facing away from the shower head base.

In any of these embodiments, the plurality of channels of the shower face can extend from a first side of the shower face to a second side opposite the first side, and each channel is formed by a first opening in the shower face on the first side and a second opening in the shower face on the second side.

In any of these embodiments, the shower face can be removably mounted to the shower head base in a first configuration in which the first side of the shower face faces outward away from the shower head base, and the first and second openings are configured to converge water flow from the second openings towards the first openings for achieving a pressure boosting mode.

In any of these embodiments, the pressure boosting mode can be configured to increase water pressure across the shower face by about 10% to about 50% compared to an incoming water line pressure.

In any of these embodiments, the shower face can be removably mounted to the shower head base in a second configuration in which the second side of the shower face faces outward away from the shower head base, and the first and second openings are configured to diverge water flow from the first openings towards the second openings for achieving a coverage boosting mode.

In any of these embodiments, the coverage boosting mode can be configured to increase spread of water across the shower surface by about 10% to about 50% compared to an incoming spread at the first openings.

In any of these embodiments, the plurality of channels can include one or more sets of channels that have a same channel shape.

In any of these embodiments, the plurality of channels can be shaped and patterned across the shower face for achieving a pressure mode that is dependent on which side of the shower face is facing away from the shower head base.

In any of these embodiments, a plurality of nozzles can extend through the plurality of channels, outward from a first side of the shower face, and outward from a second side opposite the first side of the shower face.

In any of these embodiments, the shower face can include a shower plate and one or more exchangeable intermediate pieces removably mounted to the shower plate, the shower plate comprises the plurality of channels and the one or more exchangeable intermediate pieces comprise the plurality of nozzles, wherein the plurality of nozzles of each exchangeable intermediate piece comprise a pattern for changing spray characteristics across the shower face.

In any of these embodiments, the one or more exchangeable intermediate pieces can be dual-sided and configured to be mounted to the shower plate with either side facing the shower plate.

In any of these embodiments, the one or more exchangeable intermediate pieces can be made of one or more of polyoxymethylene, acrylonitrile butadiene styrene, and nylon and the shower plate can be made of one or more of acrylonitrile butadiene styrene, thermoplastic elastomer/thermoplastic rubber, silicone, and stainless steel.

In any of these embodiments, the user-activated mechanism can be a push button.

According to some embodiments, a method for configuring a shower head includes: removing a shower face from a shower head base of the shower head; when the shower face is removed from the shower head base, configuring the shower face to deliver water through the shower face according to one of a plurality of pressure modes; and mounting the shower face configured to one of the plurality of pressure modes to the shower head base.

In any of these embodiments, the shower face can be dual-sided and configuring the shower face can include reversing the shower face to change a side of the shower face that is directed away from the shower head base when the shower face is mounted to the shower head base.

In any of these embodiments, when a first side of the shower face is oriented to face away from the shower head base, the shower face can be configured to deliver water in a pressure boosting mode, and when a second side of the shower face opposite the first side is oriented to face away from the shower head base, the shower face can be configured to deliver water in a coverage boosting mode.

In any of these embodiments, configuring the shower face can include replacing the shower face with another shower face configured to mount to the shower face.

In any of these embodiments, the shower face can include one or more exchangeable intermediate pieces and configuring the shower face can include removing the one or more exchangeable intermediate pieces.

In any of these embodiments, the method can include reversing the one or more exchangeable intermediate pieces to change a side of the one or more intermediate pieces that is directed away from the shower head when the shower face is mounted to the shower head base.

In any of these embodiments, when a first side of one or more exchangeable intermediate pieces is oriented to face away from the shower head base, the shower face can be configured to deliver water in a pressure boosting mode, and when a second side of the one or more exchangeable intermediate layers opposite the first side is oriented to face away from the shower head base, the shower face can be configured to deliver water in a coverage boosting mode.

In any of these embodiments, the method can include cleaning internal components of the shower face and shower head base.

According to some embodiments, a shower head modular assembly includes: a shower head base; one or more shower faces configured to be to removably mounted to the shower head base, each shower face comprising a plurality of channels configured to deliver a spray and extend between openings on opposite sides of each shower face; and a user-activated mechanism for dismounting a shower face of the one or more shower faces mounted to the shower head base to allow customization of the spray exiting the one or more shower faces.

In any of these embodiments, at least one of the one or more shower faces can be configured to be removably mounted to the shower head base with either side facing away from the shower head base.

In any of these embodiments, when a first side of the shower face is directed away from the shower head base, the shower face can be configured to deliver the spray in a pressure boosting mode, and when a second side of the shower face opposite the first side is directed away from the shower head base, the shower face can be configured to deliver the spray in coverage boosting mode.

According to some embodiments, a shower head modular assembly can include: a shower head base; a shower face comprising a shower plate that comprises a plurality of channels for passing water; one or more exchangeable intermediate pieces comprising a plurality of nozzles that align with the plurality of channels of the shower face, each exchangeable intermediate piece is configured to be removably mounted to the shower plate; and a user-activated mechanism for removing the shower face from the shower head base to allow customization of the spray exiting the shower face.

In any of these embodiments, at least one of the one or more exchangeable intermediate pieces can be dual-sided and configured to be removably mounted to the shower head base with either side facing away from the shower head base.

In any of these embodiments, when a first side of the at least one exchangeable intermediate pieces is oriented to face away from the shower head base, the shower face can be configured to deliver the spray in a pressure boosting mode, and when a second side of the at least one exchangeable intermediate piece opposite the first side is oriented to face away from the shower head base, the shower face can be configured to deliver the spray in a coverage boosting mode.

### BRIEF DESCRIPTION OF THE FIGURES

The disclosure will now be described, by way of example only, with reference to the accompanying drawings, in which:

FIG. 1 shows an example of a shower head that includes a shower face mounted to a shower head base, according to some embodiments.

FIG. 2 shows a shower face mounted to a shower head base and configured to deliver a spray in pressure boosting mode, according to some embodiments.

FIG. 3A shows a user-activated actuator in a non-activated position, according to some embodiments.

FIG. 3B shows a user-activated actuator in an activated position, according to some embodiments.

FIG. 4 shows a shower face mounted to a shower head base and configured to deliver a spray in a coverage boosting mode.

FIG. 5A shows an exploded view of an exemplary a shower head that includes a shower head base configured to mount one of a plurality of shower faces. In the example of FIG. 5A, a shower face configured for boosting water pressure is mountable to a shower head base.

FIG. 5B shows an exploded view of an exemplary shower head that includes a shower head base configured to mount one of a plurality of shower faces. In the example of FIG. 5B, a shower face configured for boosting spray coverage is mountable to the shower head base.

FIG. 6A shows an exploded view of an exemplary shower head that includes an intermediate piece and a shower plate, according to some embodiments. In the example of FIG. 6A, an intermediate piece configured for boosting water pressure is mountable to the shower plate.

FIG. 6B shows an exploded view of an exemplary shower head that includes an intermediate piece and a shower plate, according to some embodiments. In the example of FIG. 6B, an intermediate piece configured for boosting spray coverage is mountable to the shower plate.

FIG. 7 shows an exemplary intermediate piece that includes a plurality of nozzles (for simplicity, only one nozzle is shown) that extend beyond a front side of the intermediate piece, according to some embodiments.

FIG. 8 shows an exemplary flow chart that describes a method for configuring a shower face, according to some embodiments.

### DETAILED DESCRIPTION

Devices, systems, and methods according to various embodiments described herein include a shower head that includes a shower head base and a shower face removably mounted to the shower head base such that a user may dismount the shower face from the shower head base to clean the shower face and configure the shower face to deliver water according to one of a plurality of pressure modes. The shower face comprises a plurality of channels for passing water and when the shower face is removed from the shower head base, a user may clean water entry and exit openings of the channels to remove build-up such as limescale, mold, or dirt. Additionally, the shower head comprises a user-activated mechanism by which a user can quickly remove the shower face from the shower head base without any additional tools. By configuring the shower head in this way, a user can clean the shower head and customize their shower experience.

According to some embodiments, the shower face of the shower head may be replaceable with a different shower face for changing spray characteristics from the shower face. Each shower face may include a plurality of openings shaped, sized, and patterned to deliver a spray with specific spray characteristics. Thereby, a user can switch out shower faces to change spray characteristics and achieve a customized shower experience.

According to some embodiments, the shower face can be dual-sided and the plurality of channels of the shower face can extend from one side of the shower face to an opposite side of the shower face. Each channel can include a first opening in the shower face on a first side of the shower face and a second opening in the shower face on a second side opposite the first side of the shower face. The shower face may be configured to position the first openings or the second openings as water outlets of the shower face. According to some embodiments, each channel of the plurality of channels of the shower face can have a same shape and size. According to some embodiments, the plurality of channels of shower face can include one or more sets of channels and each set can have a same channel shape and size.

According to some embodiments, the shower face can be mounted onto the shower head base in at least two configurations. For example, a first configuration can deliver a pressure boosting mode and a second configuration can deliver a coverage boosting mode. According to some embodiments, configuring the shower face in either configuration is dependent on an orientation of the openings of the channels with respect to a direction of water flow. In the first configuration, the shower face can be mounted on the shower head base such that the first side of the shower face faces outward away from the shower head base and the second side of the shower face faces inward toward the shower head base. In this configuration, the first openings are configured to converge water flow from the second openings of the channel for achieving a pressure boosting mode through the first openings. In the second configuration, the shower face can be mounted on the shower head base such that the second side of the shower face faces outward away from the shower head base. In this configuration, the second openings are configured to diverge water flow from the first openings through the second openings for achieving a coverage boosting mode.

According to some embodiments, the shower head can include a plurality of shower faces configured to mount the shower head base for delivering a customizable shower experience. The plurality of shower faces can be reversibly mounted onto the shower head base and interchangeable with each other. According to some embodiments, the shower head can be a shower head of a hand shower.

According to some embodiments, a shower head modular assembly can include a shower head base and a plurality of shower faces for adjusting spray delivery relative to a local water supply pressure. The components (shower head base and a plurality of shower faces) of the modular assembly allow a user to configure how a shower face is mounted onto the shower head base to adjust water pressure exiting the shower face relative to local water supply pressures. Therefore, the shower head modular assembly may be used across different regions having varying household water supply pressures.

According to some embodiments, the plurality of channels of a shower face may be located on a shower plate of the shower face and the shower face may one or more exchangeable intermediate pieces that include a plurality of nozzles configured to align with the plurality of channels of the shower plate. The one or more intermediate pieces can be dual-sided and reversible such that either side can be mounted shower plate. A shape of the plurality of nozzles may be configured for changing a water pressure delivered through the shower face. According to some embodiments, each nozzle of the plurality of nozzles of the one or more intermediate pieces can have a same shape and size. According to some embodiments, the plurality of nozzles of the one or more intermediate piece can include one or more sets of nozzles and each set can have a same nozzle shape and size. According to some embodiments, the nozzles can extend outward from at least one side of at least one of exchangeable intermediate pieces. According to some embodiments, the one or more exchangeable intermediate pieces can be made of one or more of polyoxymethylene, acrylonitrile butadiene styrene, and nylon and the shower plate can be made of one or more of acrylonitrile butadiene styrene, thermoplastic elastomer/thermoplastic rubber, silicone, and stainless steel.

According to some embodiments, a shower head modular assembly can include a shower head base and one or more intermediate pieces for adjusting spray delivery relative to a local water supply pressure. According to some embodiments, the modular assembly may include a shower face that includes a shower plate and the one or more intermediate pieces. The components of the shower head modular assembly (such as a shower head base, a shower face, and one or more intermediate pieces) allow a user to configure how the one or more intermediate pieces is mounted onto the shower head base to adjust water pressure exiting the shower face relative to local water supply pressures. Therefore, the shower head modular assembly may be used in different regions having varying household water supply pressures.

In the following description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

In addition, it is also to be understood that the singular forms “a,” “an,” and “the” used in the following description are intended to include the plural forms as well, unless the context clearly indicates otherwise. It is also to be understood that the term “and/or,” as used herein, refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

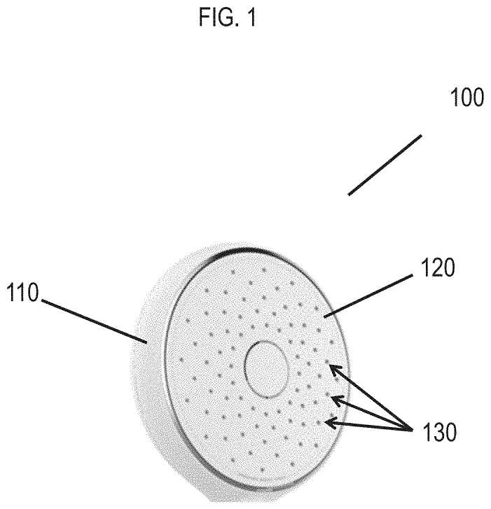

FIG. 1 shows an example of a portion of a shower head 100 that includes a shower head base 110 and a shower face 120 mounted to the shower head base 110, according to some embodiments. The shower face 120 includes a plurality of channels 130 shaped to allow water from a water line to pass from a shower head base 110 through the shower face 120. Spray characteristics from the shower face 120 depend on one or more of a shape of the channels 130, a size of channel openings, and a pattern of the channels 130 on the shower face 120. According to some embodiments, the pattern of the channels 130 span across at least about 50% of an area of the shower face 120. According to some embodiments, the pattern of the channels 130 span across at least about 60% of an area of the shower face 120. According to some embodiments, the pattern of the channels 130 span across at least about 70% of an area of the shower face 120. According to some embodiments, the pattern of the channels 130 span across at most about 95% of an area of the shower face 120. According to some embodiments, the pattern of the channels 130 span across at most about 90% of an area of the shower face 120. According to some embodiments, the pattern of the channels 130 span across at most about 80% of an area of the shower face 120. According to some embodiments, the pattern of the channels 130 span across about 50% to about 95%, or about 60% to about 90%, or about 70% to about 80% of an area of the shower face 120.

The pattern may form one or more geometric shapes (such as circles, triangles, rectangles, polygons) across the shower face to deliver water across a majority of an area of the shower face 130. According to some embodiments, the shower face 120 may be made of acrylonitrile butadiene styrene (ABS) with plated surface, thermoplastic elastomer/thermoplastic rubber (TPR/TPE), silicone, and stainless steel.

According to some embodiments, the shower head 100 may be configured to deliver a spray in a pressure boosting mode or in a coverage boosting mode based on a configuration of the shower face 120. The spray mode can be dependent on one or more of a shape, pattern, size, and orientation of the channels 130 of the shower face 120. Each channel can include at least two openings (an inlet and an outlet) located on opposite sides of the shower face 120.

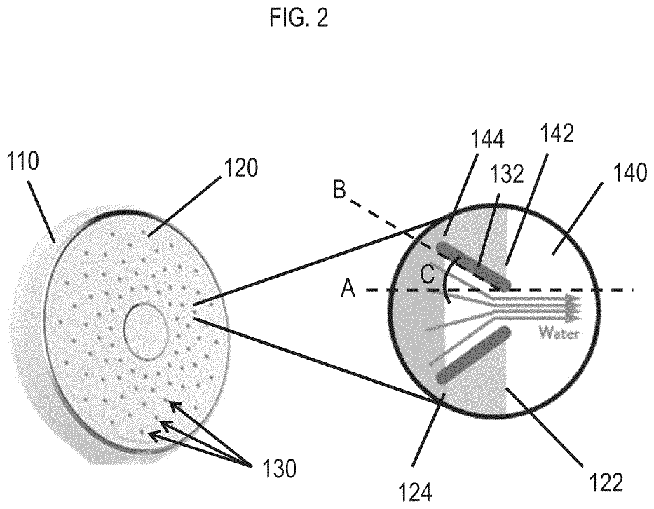

FIG. 2 shows the shower face 120 mounted to the shower head base 110 and configured to deliver a spray in pressure boosting mode 140, according to some embodiments. The pressure boosting mode can be used to achieve a relaxing shower experience in which the water pressure is sufficient for targeting areas to be cleaned. In the pressure boosting mode, the shower face 120 is configured to converge water passing through the channels 130 of the shower face 120 and increase a pressure of water exiting the shower face 120 compared to water entering the shower face 120. The inset of FIG. 2 shows a cross-sectional view of the shower face 120 configured to achieve a pressure boosting mode. The shower face 120 include channels 130 and each channel includes openings through which water enters and exits each channel 130. A first opening of a channel can be positioned on one side of the shower face. A second opening of a channel can be positioned on an opposite side of the shower face. According to some embodiments, a type of water flow through the channel is based at least on one or more of a size of each opening and a shape of each channel defined by the openings. As shown in the inset of FIG. 2, the shower face 120 includes a first side 122 that includes first openings 142 (which in the pressure boosting mode are outlets) and a second side 124 that include second openings 144 (which in the pressure boosting mode are inlets). Each channel 130 allows water to enter through the second openings 144 and exit the first openings 142. In the example of FIG. 2, the first openings 142 are sized smaller than the second openings 144 such that an area of the channel decreases from the second openings 144 to the first openings 142. This decrease in area allows for a greater water pressure at the first openings 142 configured as an outlet than at the second openings 144 configured as an inlet.

According to some embodiments, the shape of a channel of the shower face may form a frustum. In the example of FIG. 2, the shape of a channel 130 is a frustoconical shape. According to some embodiments, a diameter of the first openings 142 may range from about 0.1 millimeter to about 15 millimeters, or about 0.5 millimeter to about 10 millimeters, or about 1 millimeter to 5 millimeters. According to some embodiments, the second openings 144 may range from about 1 millimeters to about 20 millimeters, or about 5 millimeters to about 15 millimeters, or about 10 millimeters to about 12 millimeters. According to some embodiments, the frustoconical shape is formed by channel sidewalls that form an angle from about 30 degrees to about 70 degrees, or about 35 degrees to about 60 degrees, or about 45 degrees to about 55 degrees with respect to a normal direction of the shower surface 120. An angle C between a channel sidewall 132 with respect to a normal direction (A) of the shower surface 120 is illustrated by dashed lines A and B.

According to some embodiments, the pressure boosting mode can be configured to increase water pressure at opening 142 by at least about 10% compared to water pressure at opening 144. According to some embodiments, the pressure boosting mode can be configured to increase water pressure at opening 142 by at least about 20% compared to water pressure at opening 144. According to some embodiments, the pressure boosting mode can be configured to increase water pressure at opening 142 by at least about 30% compared to water pressure at opening 144. According to some embodiments, the pressure boosting mode can be configured to increase water pressure at opening 142 by at most about 80% compared to water pressure at opening 144. According to some embodiments, the pressure boosting mode can be configured to increase water pressure at opening 142 by at most about 60% compared to water pressure at opening 144. According to some embodiments, the pressure boosting mode can be configured to increase water pressure at opening 142 by at most about 50% compared to water pressure at opening 144. According to some embodiments, the pressure boosting mode can be configured to increase water pressure at opening 142 by about 10% to about 80%, or about 15% to about 75%, about 20% to about 60%, or about 20% to about 50% compared to water pressure at opening 144. According to some embodiments, the pressure boosting mode can be configured to increase water pressure at opening 142 by about 10% to about 50%, or about 15% to about 45%, or about 20% to about 30% compared to water pressure at opening 144.

According to some embodiments, the shower face 120 may be reversible allowing either the first openings 142 or the second openings 144 to be water inlets or water outlets. According to some embodiments, spray characteristics of the water exiting the shower face 120 through the channels 130 is dependent on which openings (either the first or second openings 142, 144) are water inlets and outlets. To change whether the first openings 142 or the second openings 144 are water outlets, the shower face 120 can be dismounted from the shower head base 110 by a user, flipped, and remounted onto the shower head base 110 in one of two orientations. That is, the shower face 120 can be dismounted from the shower head base 110 to allow a user to configure the shower face 120 to deliver a spray that has different spray characteristics. Spray characteristics can include water pressure and spray pattern.

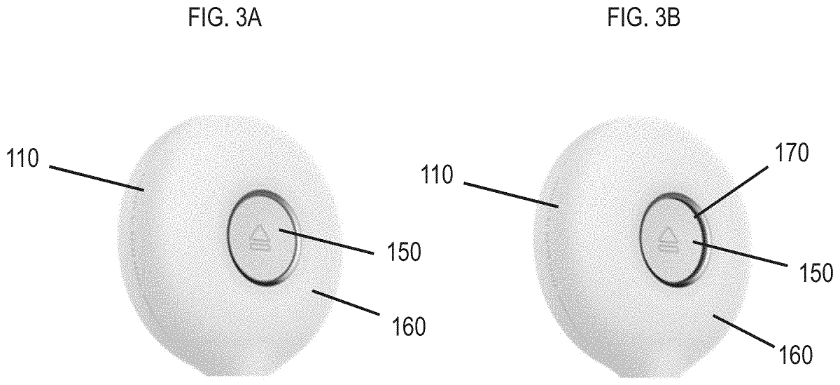

The shower face 120 can be dismounted from the shower head base 110 via a user-activated actuator. The user-activated actuator may include, for example, one or more of a push button, a lever, a rotary dial, or a combination thereof. According to some embodiments, the actuator may be located in a suitable position on or near the shower head base 110. In the example of FIG. 3A and FIG. 3B, the user-activated actuator is a push button 150 located on a backside 160 of the shower head base 110.

According to some embodiments, activation of a user-activated actuator can release or eject the shower face from the shower head. FIG. 3B shows the push button 150 in an activated position and FIG. 3A shows the push button in a non-activated position, according to some embodiments. When the push button 150 is activated, the push button 150 is configured to release the shower face 120 from the shower head base 110. According to some embodiments, when the push button 150 is in the activated position, the shower head 100 or shower head base 110 may include one or more visual indicators 170 to notify the user that the push button 150 is activated. For example, the one or more visual indicators 170 may include a color or an icon that is visible only when the push button 150 is activated or is visible only when the push button 150 is not activated.

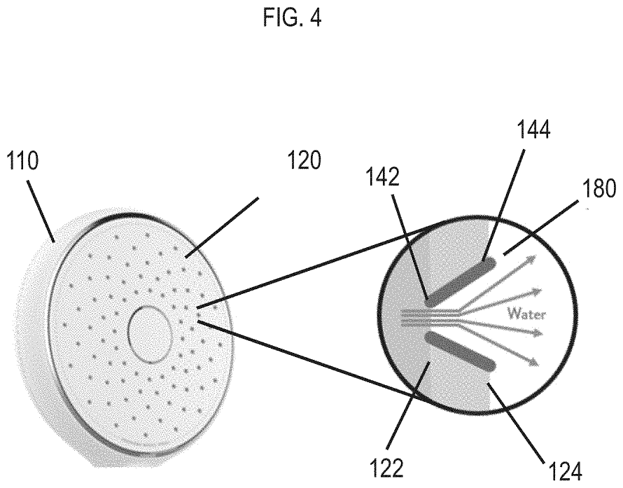

Once the shower face 120 is removed from the shower head base 110, the user may configure the shower face 120 such that the shower face 120 delivers a spray having a pattern and pressure selected by the user. According to some embodiments, the shower face 120 may be configured to diverge water passing through the shower face 120 for increasing a spray area of water exiting the shower face 120 in a coverage boosting mode. A coverage boosting mode can be helpful when using the hand shower to spray a larger area or spray an area with a low water pressure for gently cleaning. FIG. 4 shows the shower face 120 mounted to the shower head base 110 and configured to deliver a spray in a coverage boosting mode 180. In the example of FIG. 4, the shower face 120 is configured in an opposite orientation compared to the orientation shown in FIG. 2.

According to some embodiments, the shower face 120 may be dual-sided and can be configured to change between a pressure boosting and a coverage boosting mode. That is, a user of the shower head 100 may dismount dual-sided shower face 120 and customize their shower experience by changing an orientation of the shower face 120 relative to the shower head base 110 from the pressure boosting mode shown in FIG. 2 to a coverage boosting mode shown in FIG. 4 (or vice versa) and remounting the shower face 120 onto the shower head base 110. The different pressure modes are based on whether the first side 122 faces away or toward the shower head base 110. When the shower face 120 is mounted to the shower head base 110 such that the first side faces 122 faces away from the shower head base 110, then the shower face 120 is configured for the pressure boosting mode. When the shower face 120 is mounted to the shower head base 110 such that the first side 122 faces towards the shower head base 110, then the shower face 120 is configured for the coverage boosting mode.

According to some embodiments, the coverage boosting mode can be configured to increase a spray area of a spray originating from opening 142 and exiting opening 144 by at least about 10%. According to some embodiments, the coverage boosting mode can be configured to increase a spray area of a spray originating from opening 142 and exiting opening 144 by at least about 20%. According to some embodiments, the coverage boosting mode can be configured to increase a spray area of a spray originating from opening 142 and exiting opening 144 by at least about 30%. According to some embodiments, the coverage boosting mode can be configured to increase a spray area of a spray originating from opening 142 and exiting opening 144 by most about 80%. According to some embodiments, the coverage boosting mode can be configured to increase a spray area of a spray originating from opening 142 and exiting opening 144 by at most about 60%. According to some embodiments, the coverage boosting mode can be configured to increase a spray area of a spray originating from opening 142 and exiting opening 144 by at most about 50%. According to some embodiments, the coverage boosting mode can be configured to increase a spray area of a spray originating from opening 142 and exiting opening 144 by about 10% to about 80%, or about 15% to about 75%, or about 20% to about 60%, or about 20% to about 50%. According to some embodiments, the coverage boosting mode can be configured to increase a spray area of a spray originating from opening 142 and exiting opening 144 by about 10% to about 50%, or about 15% to about 45%, or about 20% to about 30%.

When the shower face is released or ejected, a user may clean the shower face 120 as needed. By configuring the shower head 100 to have a shower face that can be removed by the user without additional tools, it is feasible for the user to access an interior of the shower head 100 to remove build-up on the shower head base 110 or on either side of the shower face 120. The build-up may be due to, for example, water quality, water pressure, and flow restriction. The build-up can include one or more of sludge, mold, mildew, and dirt.

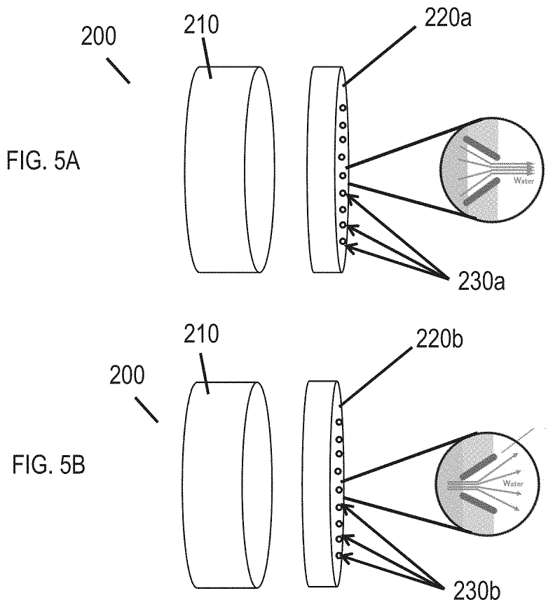

According to some embodiments, a shower head base of the shower head may be compatible with a plurality of shower faces. FIG. 5A and FIG. 5B show an exploded view of a schematic representation of an exemplary shower head 200 that includes shower head base 210 configured to mount one of a plurality of shower faces 220a, 220b. Each shower face 220a, 220b includes a plurality of channels 230a, 230b through which water flowing from a water supply line through the shower head base 210 and out through the shower face 220a, 220b. According to some embodiments, each shower face 220a, 220b may be configured to mount the shower head base 210 in only one configuration to achieve a specific pressure mode. For example, shower face 220a can be mounted to the shower head base 210 to configure the shower face 220a only for a pressure boosting mode. In contrast, shower face 220b can be mounted to the shower head base 210 to configure the shower face 220b only for a coverage boosting mode. In the example of FIG. 5A and FIG. 5B, the shower faces 220a, 220b are configured to span across a side of the shower head base 210 covering an opening of the shower head base 210. According to some embodiments, the shower faces 220a, 220b can be interchangeable and a user may choose which shower face 220a, 220b to mount onto the shower head base 210.

According to some embodiments, each shower face of a plurality of shower faces may include different shaped channels compared to other shower faces of the plurality of shower faces. According to some embodiments, each shower face of a plurality of shower faces may include different sized channels compared to other shower faces of the plurality of shower faces. Each shower face may be configured to deliver a different range of water pressures compared to other shower faces of the plurality of shower faces. According to some embodiments, different shower faces can be stacked together and mounted as a stack to the shower head base to achieve different spray characteristics exiting the outermost shower face.

According to some embodiments, a shower head modular assembly may include a shower head base and a plurality of different shower faces. The shower head modular assembly allows a user to select which shower face they would like to mount to the shower head base to achieve a type of spray characteristics deliver from the shower head. For example, the shower head modular assembly can include shower head base 210, shower face 220a for delivering a pressure boosting mode, and shower face 220b for delivering a coverage boosting mode. The modular assembly may include additional shower faces that include channels that are sized, shaped, or patterned different from channels of shower faces 220a and 220b.

According to some embodiments, a shower head may include a plurality of intermediate pieces. An intermediate piece can include a plurality of nozzles configured to direct a flow of water from a shower head base of the shower head to a shower face of the shower head. The plurality of nozzles can be configured to align with one or more of a plurality of channels in the shower face. According to some embodiments, the intermediate piece can be a flexible material to allow a user to bend the intermediate piece as need for cleaning. According to some embodiments, the intermediate piece may be made of polyoxymethylene (POM), acrylonitrile butadiene styrene (ABS), and nylon.

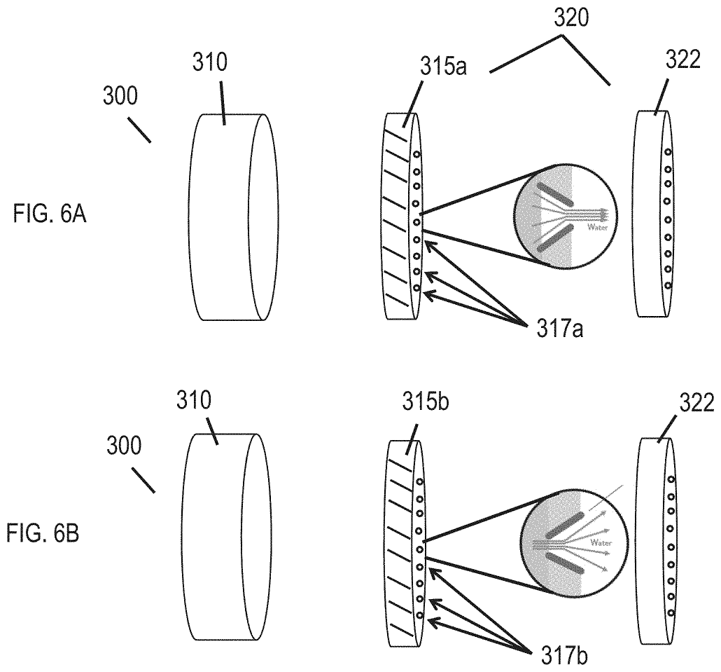

FIG. 6A shows an exploded view of a schematic representation of an exemplary shower head 300 that includes an intermediate piece 315a and a shower plate 322, according to some embodiments. The intermediate piece 315a can be configured to be positioned between shower head base 310 and shower plate 322 when the shower plate 322 is mounted to the shower head base 310. According to some embodiments, a shower face 320 may include the shower plate 322 and the intermediate piece 315a, and the intermediate piece 315a may be removable from the shower plate 322 for cleaning and configuration of the shower face 320. According to some embodiments, the shower head base 310 may include the intermediate piece 315a, and the intermediate piece 315a may be removable from the shower head base 310 for cleaning and configuration of the shower head base 310.

In the example of FIG. 6A, the intermediate piece 315a is configured for a pressure boosting mode. That is, the intermediate piece 315a includes a plurality of nozzles 317a that are shaped to converge water flow through the intermediate piece 315a. A configuration of a pressure boosting mode is provided above with reference to pressure boosting mode 140. FIG. 6B shows a schematic representation of an exemplary shower head 300 that includes an intermediate piece 315b that is different from intermediate piece 315a, according to some embodiments. In the example of FIG. 6B, the intermediate piece 315b is configured for a coverage boosting mode. That is, the intermediate piece 315b includes a plurality of nozzles 317b that are shaped to diverge water flow through the intermediate piece 315b. A configuration of a coverage boosting mode is provided above with reference to coverage boosting mode 180. According to some embodiments, the coverage boosting mode 180 can be an inverse of the pressure boosting mode.

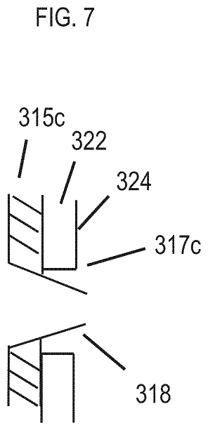

According to some embodiments, the nozzles of an intermediate piece may be configured to extend from one side of an intermediate piece to an opposite side of the intermediate piece as shown in FIGS. 6A and 6B. According to some embodiments, the nozzles of an intermediate piece can be configured to extend outward away from at least one side of the intermediate piece for guiding water flow through the shower face. FIG. 7 shows an exemplary intermediate piece 315c that includes a plurality of nozzles 318 (for illustrative purposes and simplicity, only one nozzle is shown) that extend beyond a front side of the intermediate piece 315c, according to some embodiments. According to some embodiments, the nozzles 317c can extend beyond the shower plate 322 when the shower face 320 is mounted to a shower head base. For example, FIG. 7 shows nozzle 318 extending through a channel 317c of shower plate 322 and extending outward beyond surface 324 of the shower plate 322.

According to some embodiments, at least one of the intermediate pieces may be reversibly mounted. For example, an intermediate piece may be configured to mount in the shower head such the plurality of nozzles either converge water flow as shown in example FIG. 6A or diverge water flow as shown in example FIG. 6B. According to some embodiments, an intermediate piece of the plurality of intermediate pieces is exchangeable with another intermediate piece for changing a spray characteristic of the shower head. According to some embodiments, different intermediate pieces can be stacked together and mounted as a stack to the shower head base to achieve different spray characteristics exiting the outermost shower face. According to some embodiments, a shower plate of the shower face can be mounted to a shower head base without an intermediate piece between the shower plate and shower head base.

According to some embodiments, a shower head modular assembly may include a shower head base and a plurality of intermediate pieces. Such a modular assembly allows a user to select which intermediate piece the user would like to mount to the shower face (or shower head base) to achieve a type of spray characteristics delivered from the shower head. For example, the shower head modular assembly can include shower head base 310, shower plate 322, intermediate piece 315a for achieving a pressure boosting mode, and intermediate piece 315b for achieving a coverage boosting mode. The modular assembly may include additional intermediate pieces that include nozzles that are sized, shaped, or patterned different from nozzles of intermediate pieces 315a and 315b.

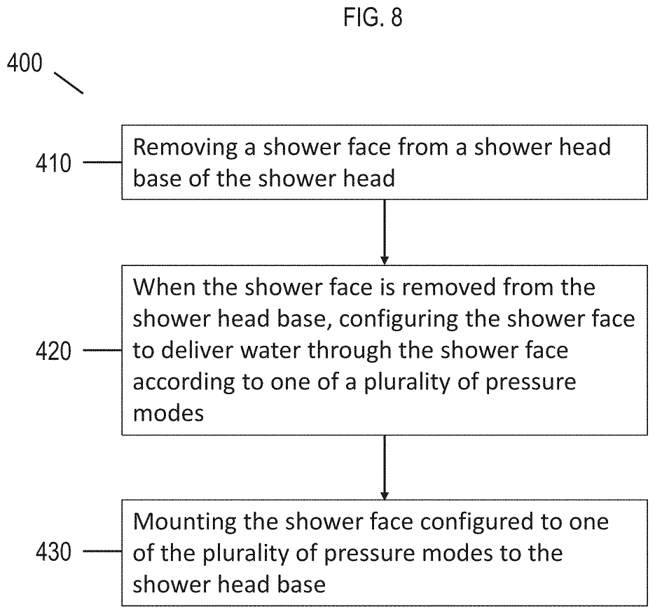

FIG. 8 shows an exemplary flow chart that describes a method 400 for configuring a shower head, according to some embodiments. Method 400 may be used for configuring a shower head such as shower heads 100, 200, 300. Method 400 may be used for configuring a shower head modular assembly that includes shower head such as shower heads 100, 200, or 300.

At step 410, a shower face may be removed from a shower head base of a shower head. According to some embodiments, the shower face may be removed via a user-activated actuator, such as push button 150. According to some embodiments, when activated, the user-activated actuated may be configured to release the shower face from the shower head base. According to some embodiments, when activated, the user-activated actuator may be configured to eject the shower face from the shower head base. Release or ejection of the shower face from the shower head base allows a user to remove or dismount the shower face from the shower head base. By configuring the shower head in this way, the shower face may be quickly removed from the shower head base without additional tools.

At step 420, when the shower face is removed from the shower head base, the shower face may be configured to deliver water through the shower face according to one of a plurality of pressure modes. According to some embodiments, one of the plurality of pressure modes can be a pressure boosting mode. A description of a pressure boosting mode is provided above in reference to pressure boosting mode 140. According to some embodiments, one of the plurality of pressure modes can be a coverage boosting mode. A description of a coverage boosting mode is provided above in reference to coverage boosting mode 180. According to some embodiments, the plurality of pressure modes may include pressure modes that deliver a spray having characteristics between a pressure boosting mode and a coverage boosting mode.

When the shower face is removed, a user may clean the both sides of the shower face and an interior of the shower head base (and shower head). In this way, the user can clean a side of the shower face that was initially mounted to face an interior of the shower head.

According to some embodiments, configuring the shower face may include changing an orientation of the shower face relative to the shower head base. For example, a user may reverse the shower face to change a side of the shower face that is directed away from the shower head base when the shower face is mounted to the shower head base. In this example, when a first side of the shower face is oriented to face away from the shower head base, the shower face may be configured to deliver water in a pressure boosting mode, and when a second side of the shower face opposite the first side is oriented to face away from the shower head base, the shower face may be configured to deliver water in a coverage boosting mode.

According to some embodiments, configuring the shower face may include exchanging out the shower face for a different shower face. That is, there may be a plurality of shower faces from which a user may choose which shower face to mount to the shower head base. Spray characteristics from each shower face is based at least partially on a shape and size of a plurality of channels of the shower face. The plurality of channels are configured for passing water and can be shaped and size to increase or decrease water pressure through the shower face. According to some embodiments, each shower face may be configured to deliver a spray with a different spray characteristic. For example, a first shower face may be configured to boost pressure, a second shower face may be configured to boost spray coverage, and a third shower face may be configured to deliver an intermediate pressure or coverage that is different from what would exit the first and second shower faces.

According to some embodiments, the shower face may include one or more intermediate pieces and configuring the shower face may include changing an orientation of at least one of the intermediate pieces relative to the shower head base. Each intermediate piece may include a plurality of nozzles configured to align with a plurality of channels in the shower face to guide water from the intermediate piece to and through the shower face. According to some embodiments, a user may reverse an intermediate piece to change a side of the intermediate piece that is directed away from the shower head base when the shower face is mounted to the shower head base. In such embodiments, when a first side of the intermediate piece is oriented to face away from the shower head base, the intermediate piece may be configured to deliver water in a pressure boosting mode through the nozzles of the intermediate piece and through the channels of the shower face. When a second side of the intermediate piece opposite the first side is oriented to face away from the shower head base, the intermediate piece may be configured to deliver water in a coverage boosting mode through the nozzles of the intermediate piece and through the channels of the shower face. According to some embodiments, the channels of the shower face may be located in a shower plate of the shower face.

According to some embodiments, when the shower face is removed, a user may clean the both sides of the shower face, both sides of the one or more intermediate pieces, and in interior of the shower head base (and shower head). In this way, the user can clean components of the shower face that were initially mounted to face an interior of the shower head.

At step 430, the shower face configured to one of the plurality of pressure modes can be mounted to the shower head base. According to some embodiments, mounting the shower face to the shower head base resets the user-activated actuator into a non-activated position.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A shower head comprising:
a shower head base;
a shower face removably mounted to the shower head base, the shower face comprising a plurality of channels configured to deliver a spray, each channel comprising openings on opposite sides of the shower face; and
a user-activated mechanism configured to remove the shower face from the shower head base to allow customization of the spray from the shower head.

2. The shower head of claim 1, wherein the shower face is replaceable with a different shower face comprising a different plurality of channels, wherein the different plurality of channels are configured to deliver a pressure boosting spray from the shower head based on a shape and pattern of the different plurality of channels.

3. The shower head of claim 1, wherein the pressure boosting spray is configured to increase water pressure across the shower face by about 10% to about 50% compared to a pressure of the spray.

4. The shower head of claim 1, wherein the shower face is mountable to the shower head base with either side facing away from the shower head base and the spray of the shower head is dependent upon which side of the shower face is facing away from the shower head base.

5. The shower head of claim 1, wherein the plurality of channels of the shower face extend from a first side of the shower face to a second side opposite the first side, and each channel is formed by a first opening in the shower face on the first side and a second opening in the shower face on the second side.

6. The shower head of claim 5, wherein the shower face is removably mounted to the shower head base in a first configuration in which the first side of the shower face faces outward away from the shower head base, and the first and second openings are configured to converge water flow from the second openings towards the first openings for achieving a pressure boosting mode.

7. The shower head of claim 6, wherein the pressure boosting mode is configured to increase water pressure across the shower face by about 10% to about 50% compared to an incoming water line pressure.

8. The shower head of claim 5, wherein the shower face is removably mounted to the shower head base in a second configuration in which the second side of the shower face faces outward away from the shower head base, and the first and second openings are configured to diverge water flow from the first openings towards the second openings for achieving a coverage boosting mode.

9. The shower head of claim 8, wherein the coverage boosting mode is configured to increase spread of water across the shower surface by about 10% to about 50% compared to an incoming spread at the first openings.

10. The shower head of claim 1, wherein the plurality of channels comprise one or more sets of channels that have a same channel shape.

11. The shower head of claim 1, wherein the plurality of channels are shaped and patterned across the shower face for achieving a pressure mode that is dependent on which side of the shower face is facing away from the shower head base.

12. The shower head of claim 1, wherein a plurality of nozzles extend through the plurality of channels, outward from a first side of the shower face, and outward from a second side opposite the first side of the shower face.

13. The shower head of claim 12, wherein the shower face comprises a shower plate and one or more exchangeable intermediate pieces removably mounted to the shower plate, the shower plate comprises the plurality of channels and the one or more exchangeable intermediate pieces comprise the plurality of nozzles, wherein the plurality of nozzles of each exchangeable intermediate piece comprise a pattern for changing spray characteristics across the shower face.

14. The shower head of claim 12, wherein the one or more exchangeable intermediate pieces are dual-sided and configured to be mounted to the shower plate with either side facing the shower plate.

15. The shower head of claim 12, wherein the one or more exchangeable intermediate pieces are made of one or more of polyoxymethylene, acrylonitrile butadiene styrene, and nylon and the shower plate is made of one or more of acrylonitrile butadiene styrene, thermoplastic elastomer/thermoplastic rubber, silicone, and stainless steel.

16. The shower head of claim 1, wherein the user-activated mechanism is a push button.

17. A shower head modular assembly, comprising:
a shower head base;
one or more shower faces configured to be to removably mounted to the shower head base, each shower face comprising a plurality of channels configured to deliver a spray and extend between openings on opposite sides of each shower face; and
a user-activated mechanism for dismounting a shower face of the one or more shower faces mounted to the shower head base to allow customization of the spray exiting the one or more shower faces.

18. The modular assembly of claim 17, wherein at least one of the one or more shower faces is configured to be removably mounted to the shower head base with either side facing away from the shower head base.

19. The modular assembly of claim 18, wherein when a first side of the shower face is directed away from the shower head base, the shower face is configured to deliver the spray in a pressure boosting mode, and when a second side of the shower face opposite the first side is directed away from the shower head base, the shower face is configured to deliver the spray in coverage boosting mode.

20. A shower head modular assembly, comprising:
a shower head base;
a shower face comprising a shower plate that comprises a plurality of channels for passing water;
one or more exchangeable intermediate pieces comprising a plurality of nozzles that align with the plurality of channels of the shower face, each exchangeable intermediate piece is configured to be removably mounted to the shower plate; and
a user-activated mechanism for removing the shower face from the shower head base to allow customization of the spray exiting the shower face.
